(19) United States
(12) Patent Application Publication
(10) Pub. No.: US 2007/0186276 A1
(43) Pub. Date: Aug. 9, 2007

(54) Auto-detection and notification of access point identity theft

(76) Inventors: Matthew McRae, Laguna Beach, CA (US); Kendra S. Harrington, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/350,707

(22) Filed: Feb. 9, 2006

(51) Int. Cl. H04L 9/32

(52) U.S. Cl. 726/4

(57) ABSTRACT

Systems and techniques for detecting rogue access points. A wireless signal may be received from a wireless device. The wireless device may be determined to be a candidate device based on network identification information. Additional information associated with the wireless device may be acquired, and the wireless device may be determined to be a rogue device based on the additional information. Notification information indicative of the determination may be transmitted.

### BACKGROUND

1. Field of Invention

This invention generally relates wireless access and, more particularly, to secure techniques for wireless access.

2. Related Art

Wireless networking provides much-needed flexibility and convenience, compared to wired networking. One important feature of wireless networking is the ability to connect to the information infrastructure at locations other than a user's home or office (although wireless networks are widely used in homes and offices as well). Wireless networking allows users to work in locations such as libraries, hotels, airports, cafés, and the like, depending on the availability of accessible wireless access points.

Wireless access points (APs) are wireless-capable devices that connect users to information networks. APs that provide access to users in public locations (either as a free service or through a commercial service provider) may be referred to as “hot spots.” Access to any AP may require a user to provide identification information (such as a personal identification number) to access network services through the AP, or may allow access to all users.

Service providers (such as T-Mobile, SBC, Boingo, and other service providers) are rapidly deploying wireless access points to improve availability and improve the quality of wireless access. In return, the service providers charge subscribers for access. Accordingly, the service provider stores personal information as part of a subscriber profile associated with each subscriber account. The personal information may include information such as a telephone number, address, and credit card number. A user may be able to view and edit personal information by logging into the service provider's system.

However, the flexibility provided by public access to wireless networking may leave user accounts vulnerable to malicious “eavesdropping.” A malicious user can copy the web pages and screens off the real public hot spot (e.g., the authentication screens, portal, or walled garden content) to mimic its look and feel. The malicious user can then set up a laptop in a public space that offers access from that carrier (e.g., a coffee shop), set the laptop in “access point” or AP mode, and start a web server.

Most user systems associate with the strongest signal, so that if any user is positioned closer to the malicious false AP (which may be referred to as a “rogue” AP), the subscriber would unknowingly log into the rogue AP (the laptop) rather than the actual public AP. When the user unwittingly “logs in” to the rogue AP, the person's credentials are captured. The malicious user may then take over the account by changing the login credentials, and may steal the user's personal information.

### BRIEF DESCRIPTION OF THE DRAWINGS

FIG. 1 is a block diagram of a system for detection of rogue access points, in some embodiments; and

FIG. 2 shows a method to identify rogue access points in a system such as that shown in FIG. 1, in some embodiments.

Like reference symbols in the various drawings indicate like elements.

### DETAILED DESCRIPTION

Identity theft can be costly and frustrating to subscribers, and may slow adoption of new technology. The 802.11k standard recognizes the problems associated with AP mimicking. It defines an “evil twin” AP as one of two APs having the same MAC address (media access control address), where one is a legitimate AP and the “evil twin” is a rogue AP spoofing the original's MAC ID. However, a rogue AP can mimic an AP in more ways than anticipated by the standard. For example, a resourceful thief could create an AP that mimics not just the MAC ID, but the SSID (service set ID), beacons, probes, and other pieces of information detectable outside the AP. For example, a rogue AP could just mimic the SSID and web page content of the real AP without mimicking the MAC ID and thus not be classified as an evil twin AP.

Systems and techniques described herein may provide real-time identification of rogue APs, enabling real-time notification and alerting, as well as information acquisition to assist in the apprehension of those responsible for the rogue AP and those whose personal information may have been compromised. Techniques for mitigating the occurrence of false alarms are also provided.

In some embodiments, the systems and techniques may be used with 802.11 compliant wireless networks. In 802.11 networks, a number of different frame types are used to communicate information among different devices. For example, an AP periodically sends a beacon frame to announce its presence to other wireless devices, and to relay information such as its SSID, timestamp, etc. Wireless devices may send a probe request frame when they need information from other devices. In response, one or more APs may respond with a probe response frame. For example, an AP may respond with a probe response frame including capability information, supported data rates, etc.

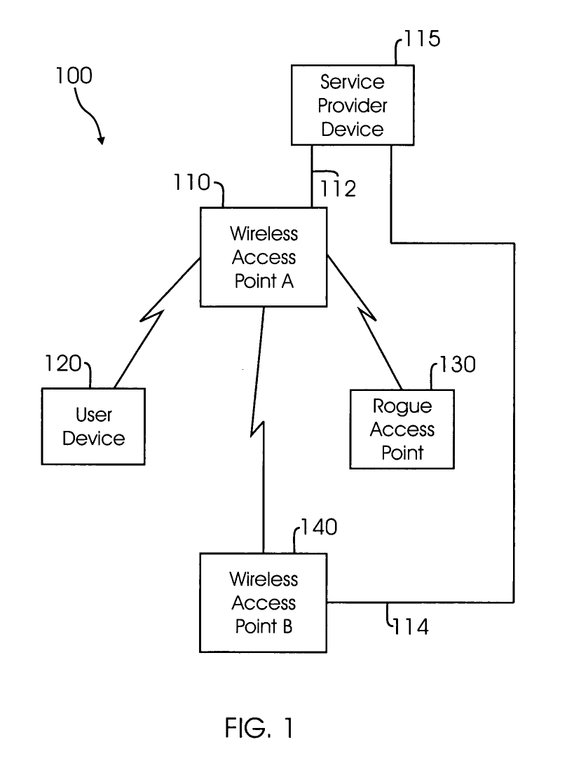

FIG. 1 shows a system 100 that may be used to detect a rogue AP, according to some embodiments. For illustrative purposes, system 100 includes two legitimate wireless access points 110 and 140, and one rogue wireless access point 130 (which may not be a real access point at all, but may instead be a different type of wireless device such as a mobile computing device configured to mimic a legitimate AP).

First wireless access point 110 provides access to an information network (such as the Internet) to wireless-enabled devices such as a user device 120. In some embodiments, access point 110 may allow network access using a commercial service (such as T-Mobile), while in other embodiments, first access point 110 may allow network access via a public service. First access point 110 is in communication with a service provider device 115 (such as a server) via a wired or wireless connection 112. First access point 110 and service provider device 115 include memory to store at least one of data and instructions to implement the techniques described herein, and one or more processors to execute instructions.

System 100 may also include a second wireless access point 140, which may allow network access via the same or a different service than that of first access point 110. FIG. 1 illustrates an embodiment in which second wireless access point 140 is associated with the same service as access point 110, and is in communication with service provider device 115 via a wired or wireless connection 114. System 100 also includes a rogue access point 130, which may comprise a device such as a wireless-enabled portable computer configured to mimic a legitimate AP in the same network as first access point 110.

First access point 110 may include a wireless interface, which may include one or more antennae, as well as software and/or hardware to process signals received over the antennae. First access point 110 may further include one or more processors configured to process instructions and data to implement acts of the methods described herein. The one or more processors may be further configured to process instructions and data to enable first access point 110 to receive data over the wireless interface, and to process the received data. First access point 110 may further include memory to store instructions and/or data. As noted above, first access point 110 may also include a wired interface to communicate with one or more additional devices (such as device 115) over connection 112.

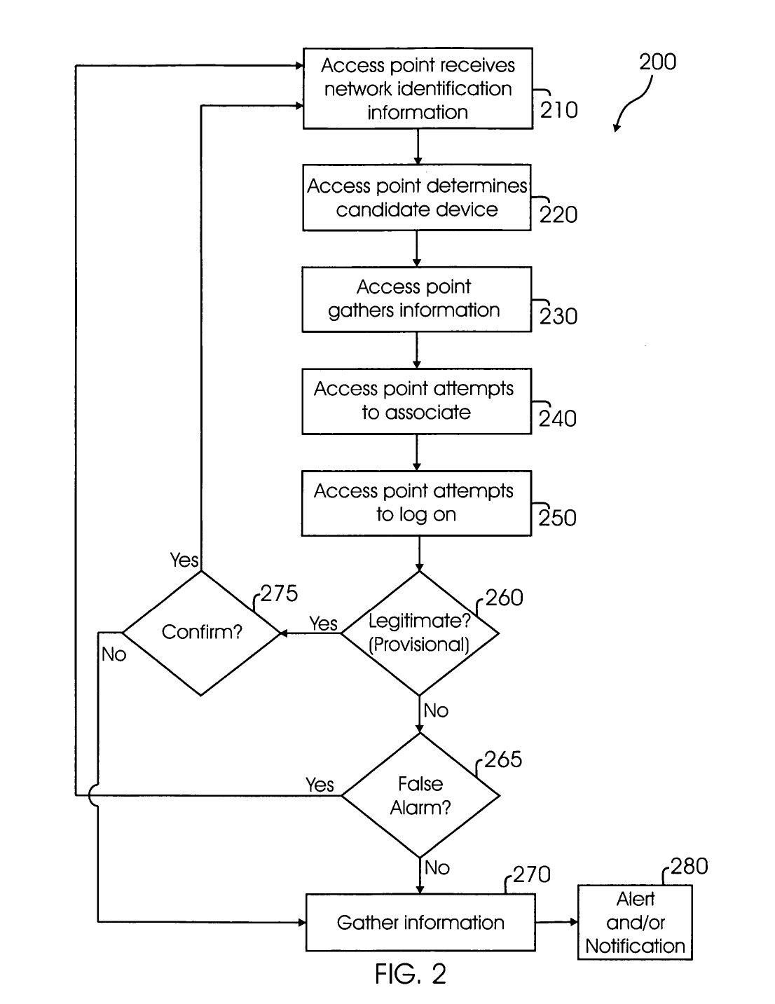

FIG. 2 shows a method 200 that may be used to determine whether a particular candidate wireless device is a rogue AP, according to some embodiments. Acts of method 200 may be implemented using a wireless access point such as first wireless access point 110 of FIG. 1, which may execute program steps and/or transmit data to implement method 200. As noted above, first access point 110 may be in communication with other devices such as device 115 via either a wireless or wired connection. Device 115 may perform one or more acts to implement method 200, and may provide data and/or instructions to first wireless access point 110.

In order to detect candidate devices that may be rogue APs, first access point 110 is configured to listen for other devices appearing to be APs. Referring to FIGS. 1 and 2, at 210, first access point 110 may receive network identification information from one or more wireless devices. For example, first access point 110 may receive a beacon frame including a service set ID (SSID) (which is generally an extended service set ID or ESSID for wireless networks with access points). At 220, first access point 110 may determine that a wireless device is a candidate wireless device based on the network identification information.

First access point 110 may determine that a device is a candidate device based on the received network identification information; for example, based on one or more particular network identifiers. In the exemplary embodiment described below, candidate wireless devices are those with the same network identifier as first access point 110 (e.g., if first access point 110 is a T-Mobile access point, candidate wireless devices are those with network identifiers indicative of a T-Mobile access point). The candidate wireless devices are either legitimate access points, or rogue access points.

Since access point 130 is a rogue access point mimicking a legitimate access point in the same network as first access point 110, it is detected as a candidate wireless device. Second access point 140 is also detected as a candidate wireless device if it is part of the same network as first access point 110. However, if second access point 140 is a known true AP, first access point may determine that it is not a candidate wireless device. For example, if first access point 110 and second access point 140 are connected using a wired backbone configuration, access point 110 may determine that second access point 140 is a known true AP by sending authentication packets via the wired backbone and receiving an appropriate response.

At 230, first access point 110 acquires information from detected candidate wireless devices and analyzes the acquired information. At least some of the information may be obtained in the same manner in which the candidate devices are detected (e.g., in a beacon frame received from the candidate wireless devices). Additional information may be obtained by transmitting one or more requests for information (e.g., a probe request frame) to the candidate devices and receiving information in response (e.g., a probe response frame). If a candidate device fails to respond to a request for information, or responds incorrectly, first access point 110 may use this information to provisionally determine that the candidate is a rogue access point.

If first access point 110 is unable to determine that a candidate device is a legitimate AP based on the acquired information, first access point 110 may attempt to associate with the candidate device at 240 (to establish a wireless connection with the candidate device). If first access point 110 is able to associate with the candidate device, it may obtain additional information such as the device IP address, etc. In addition, first access point 110 may be able to acquire information such as identity information for other clients connected to the candidate device. If the candidate device is determined to be a rogue AP, this information may be used to identify and notify potential victims.

If first access point 110 is able to associate with the candidate device, it may then attempt to login to the service associated with the service identifier using known good credentials at 250. If the known good credentials are accepted and access is gained, access point 110 may provisionally determine that rogue access point 130 is legitimate at 260. However, this determination may not be conclusive, since a rogue AP may be able to mimic connection with the service provider. For example, if the rogue AP is a laptop with WAN access via a 3G card, it might present a user interface mimicking the login interface of the service provider, accept all credentials, and provide Internet access to all users.

Therefore, first access point 110 may confirm that the access point is legitimate at 275. For example, first access point 110 may verify that rogue access point 130 is legitimate by sending traffic across rogue access point 130 to confirm that it is actually connected to and managed by the service provider. If it is not (as here), first access point determines that rogue access point 130 is indeed a rogue, may gather additional information at 270, and may implement one or more alert and/or notification processes at 280. If the access point is determined to be legitimate, first access point 110 may continue to listen for other access points at 210.

If the credentials are rejected or access is not gained, first access point 110 may provisionally determine that the candidate device (e.g., rogue access point 130) is a rogue AP. First access point 110 may then collect additional information such as HTTP commands, web server type, file names, IP addresses, MAC IDs, etc. at 270. In some embodiments, at 265, first access point 110 may also attempt to determine whether the identification is a false alarm; that is, whether the access point is indeed legitimate but for some reason is not responding as expected. For example, first access point 110 may attempt to send traffic across rogue access point 130 to determine whether it is connected to the Internet and providing actual service, and/or if it is actually connected to and managed by the service provider.

At 280, first access point 110 may take one or more actions to report rogue access point 130, and/or to alert other parties to the existence of a rogue access point. For example, access point 110 may create an audible, visual, and/or other alert onsite, so that the local proprietor can immediately locate the perpetrator inside the establishment. An onsite alert such as an alarm and/or bright LED or other light may also provide notification to users that a rogue AP has been detected.

Notification and/or alert may also occur over one or more networks. For example, access point 110 may issue a network-wide notification via netsend. Alternately, it can send a “rogue AP detected” information element or IE in an 802.11 beacon frame. Network users would thus be alerted to the fact that a rogue AP has been detected. Users may notify the proprietor, and may also discontinue network use until the threat has been diminished or eliminated.

Access point 110 may also notify the service provider, and may report the information collected, as well as associated information such as the incident time, location, etc. This may be used to track down the perpetrator (e.g., to identify the perpetrator from surveillance tape). Obtained information could also be used with other information (e.g., logs) to determine a pattern, or track down the perpetrator.

Other notification and/or alert techniques may be used. For example, parties may be notified using SMS (short message service), email, IM (instant messenger), etc. The notified/alerted parties may include the service provider, one or more end users, a proprietor or other person at the AP location, and/or one or more law enforcement services.

The systems and techniques described herein provide more flexible methods of preventing/mitigating the potential problems of rogue APs. The enhanced flexibility arises from the inclusion of techniques to confirm the legitimacy of an AP, as well as to confirm a provisional identification as a rogue AP. For example, in wireless networking environments where network availability is a primary goal, an AP may perform more extensive false alarm mitigation after provisionally determining that a device is a rogue AP. By contrast, in wireless networking environments where network security is more important, the AP may require more extensive confirmation that an AP is legitimate after a provisional determination.

In implementations, the above described techniques and their variations may be implemented at least partially as computer software instructions. Such instructions may be stored on one or more machine-readable storage media or devices and are executed by, e.g., one or more computer processors, or cause the machine, to perform the described functions and operations. As noted above, acts of method 200 may be implemented at least partially by a device separate from first wireless access point 110, such as service provider device 115. A separate device may also provide data and/or instructions to first wireless access point 110 to implement at least some acts of method 200. In addition, the above described techniques and their variations may be implemented at least partially as hardware, which may be included in first wireless access point 110, service provider device 115, and/or other device.

A number of implementations have been described. Although only a few implementations have been disclosed in detail above, other modifications are possible, and this disclosure is intended to cover all such modifications, and most particularly, any modification which might be predictable to a person having ordinary skill in the art.

Also, only those claims which use the word “means” are intended to be interpreted under 35 USC 112, sixth paragraph. Moreover, no limitations from the specification are intended to be read into any claims, unless those limitations are expressly included in the claims. Accordingly, other embodiments are within the scope of the following claims.

What is claimed is:

1. A method comprising:
receiving a wireless signal from a wireless device at an access point associated with a particular service provider, the wireless signal including network identification information;
determining that the wireless device is a candidate device using the network identification information;
acquiring additional information associated with the wireless device at the access point associated with the particular service provider; and
determining that the wireless device is a rogue access point or a legitimate access point based on the additional information.

2. The method of claim 1, further comprising:
prior to determining that the wireless device a rogue access point or a legitimate access point, provisionally determining that the wireless device is a rogue access point.

3. The method of claim 2, further comprising:
determining that the provisional determination that the wireless device is a rogue access point is false; and
wherein determining that the wireless device comprises determining that the wireless device is a legitimate access point.

4. The method of claim 1, further comprising:
prior to determining that the wireless device is a rogue access point or a legitimate access point, provisionally determining that the wireless device is a legitimate access point.

5. The method of claim 1 wherein determining that the wireless device is a rogue access point or a legitimate access point comprises determining that the wireless device is a rogue access point, and further comprising:
transmitting notification information indicative of the determining that the wireless device is a rogue access point.

6. The method of claim 1, wherein acquiring additional information from the wireless device at the access point comprises:
establishing a wireless connection with the wireless device and attempting to log in to the particular service provider using the established wireless connection.

7. The method of claim 6, wherein attempting to log in to the particular service provider comprises transmitting information indicative of known good credentials for the particular service provider over the established wireless connection.

8. A wireless access system, comprising:
a wireless access point device configured to receive wireless signals and to provide wireless access to an information network, the wireless access point device including:
a wireless interface configured to receive the wireless signals;
one or more processors configured to process information included in the wireless signals; and
memory configured to store instructions that, when executing, cause the one or more processors to perform the steps of:
determining a network identifier for a wireless device based on a received wireless signal, the network identifier indicative of a particular service provider;
acquiring additional information associated with the wireless device; and
determining that the wireless device is a rogue access point or a legitimate access point based on the additional information.

9. The system of claim 8, further comprising:
a network device associated with the particular service provider in communication with the wireless access point, and wherein determining that the wireless device is a rogue access point or a legitimate point comprises determining that the wireless device is a rogue access point, and wherein the network device is configured to receive information indicative of the determining that the wireless device is a rogue access point and further configured to generate notification information.

10. The system of claim 9, wherein the network device is configured to transmit the notification information to an alert system.

11. A wireless access system comprising:
means for receiving wireless signals and providing wireless access to an information network;
means for determining a network identifier for a wireless device based on a received wireless signal, the network identifier indicative of a particular service provider;
means for acquiring additional information associated with the wireless device; and
means for determining that the wireless device is a rogue access point or a legitimate access point based on the additional information.

12. An article comprising a machine-readable medium embodying information indicative of instructions that when performed by one or more machines result in operations comprising:
receiving a wireless signal from a wireless device at an access point associated with a particular service provider, the wireless signal including network identification information;
determining that the wireless device is a candidate device using the network identification information;
acquiring additional information associated with the wireless device at the access point associated with the particular service provider;
determining that the wireless device is a rogue access point based on the additional information; and
transmitting notification information indicative of the determining that the wireless device is a rogue access point.

13. The article of claim 12, wherein acquiring additional information from the wireless device at the access point comprises:
establishing a wireless connection with the wireless device.

14. The article of claim 13, wherein acquiring additional information from the wireless device at the access point comprises:
attempting to log in to the particular service provider using the established wireless connection.

15. The article of claim 14, wherein attempting to log in to the particular service provider comprises transmitting information indicative of known good credentials for the particular service provider over the established wireless connection.

16. The article of claim 14, wherein acquiring additional information associated with the wireless device comprises determining that the attempting to log in to the particular service provider was unsuccessful.
